(19) United States
(12) Patent Application Publication
(10) Pub. No.: US 2020/0367717 A1
(43) Pub. Date: Nov. 26, 2020

(54) Sole Cleaning Device

(71) Applicant: Jacob Mayfield, Durham, NC (US)

(72) Inventor: Jacob Mayfield, Durham, NC (US)

(21) Appl. No.: 16/418,675

(22) Filed: May 21, 2019

(51) Int. Cl. A47L 23/22; B08B 7/00; C09J 7/38

(52) U.S. Cl. CPC A47L 23/22; C09J 7/38; B08B 7/0028

(57) ABSTRACT

A sole cleaning device for footwear includes a first panel and a second panel that is sized and shaped complementarily to the first panel. The first panel is sized so that the first panel is configured to substantially overlay a sole of an article of footwear. An adhesive is coupled to and substantially covers an upper surface of the first panel. The second panel is removably coupled to the adhesive so that the second panel is selectively detachable from the adhesive. The first panel is configured to overlay the sole of the article of footwear, positioning the adhesive to bind to debris that is adhering to the sole so that the debris is removed from the sole as the first panel is peeled from the sole.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relate to cleaning devices and more particularly pertain to a new cleaning device for footwear.

### BRIEF SUMMARY OF THE INVENTION

An embodiment of the disclosure meets the needs presented above by generally comprising a first panel and a second panel that is sized and shaped complementarily to the first panel. The first panel is sized so that the first panel is configured to substantially overlay a sole of an article of footwear. An adhesive is coupled to and substantially covers an upper surface of the first panel. The second panel is removably coupled to the adhesive so that the second panel is selectively detachable from the adhesive. The first panel is configured to overlay the sole of the article of footwear, positioning the adhesive to bind to debris that is adhering to the sole so that the debris is removed from the sole as the first panel is peeled from the sole.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric perspective view of a sole cleaning device according to an embodiment of the disclosure.

FIG. 2 is a bottom view of an embodiment of the disclosure.

FIG. 3 is a cross-sectional view of an embodiment of the disclosure.

FIG. 4 is an in-use view of an embodiment of the disclosure.

### DETAILED DESCRIPTION OF THE INVENTION

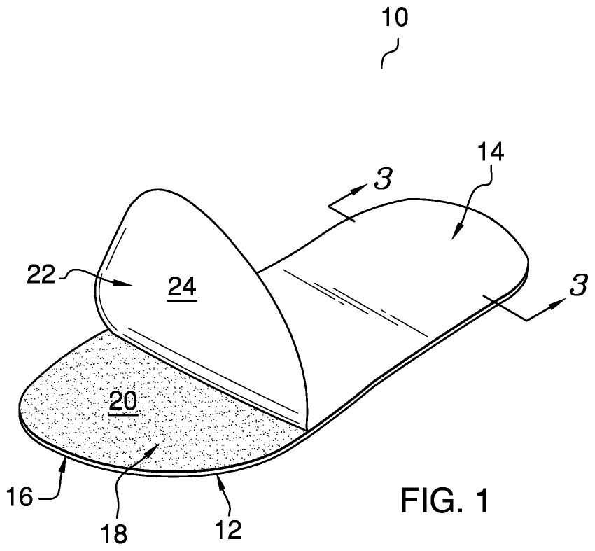

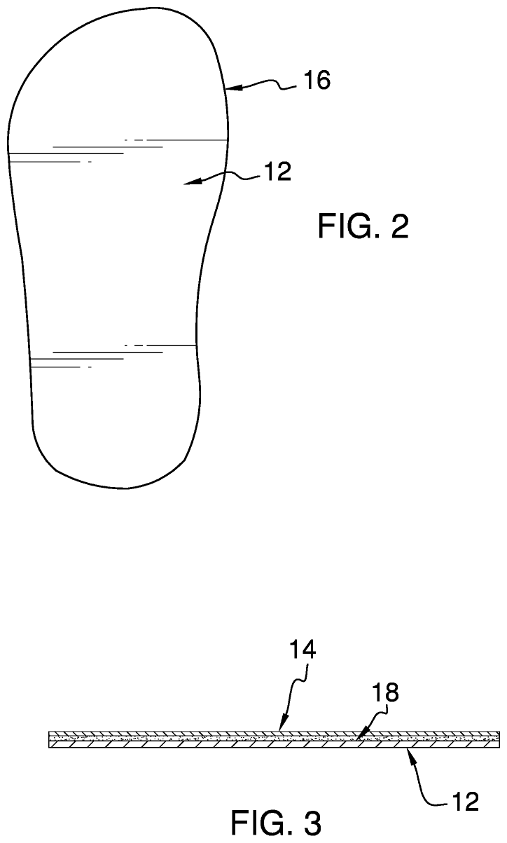

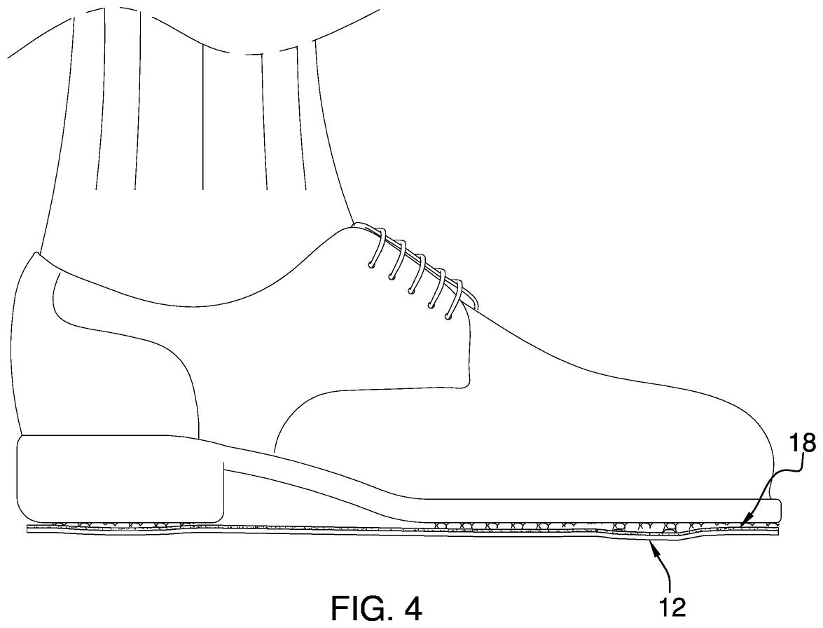

With reference now to the drawings, and in particular to FIGS. 1 through 4 thereof, a new cleaning device embodying the principles and concepts of an embodiment of the disclosure and generally designated by the reference numeral 10 will be described.

As best illustrated in FIGS. 1 through 4, the sole cleaning device 10 generally comprises a first panel 12 and a second panel 14 that is sized and shaped complementarily to the first panel 12. The first panel 12 is sized so that the first panel 12 is configured to substantially overlay a sole of an article of footwear, as shown in FIG. 4.

The first panel 12 has a perimeter 16 that is shaped complementary to a circumference of the sole of the article of footwear. The first panel 12 is flexible and is configured to conform to contours of the sole of the article of footwear. The first panel 12 comprises at least one of plastic and paper stock.

An adhesive 18 is coupled to and substantially covers an upper surface 20 of the first panel 12. The adhesive 18 is pressure sensitive type so that the adhesive 18 is configured to bond under application of light pressure. The pressure exerted by a mass of a user through the sole of the article of footwear positioned the adhesive 18 to bond to the sole and to debris that is adhering to the sole.

The second panel 14 is removably coupled to the adhesive 18 so that the second panel 14 is selectively detachable from the adhesive 18, as shown in FIG. 1. The first panel 12 is configured to overlay the sole of the article of footwear, positioning the adhesive 18 to bind to the debris that is adhering to the sole so that the debris is removed from the sole as the first panel 12 is peeled from the sole. The second panel 14 comprises at least one of paper and plastic.

A release agent 22 is positioned on a lower face 24 of the second panel 14 so that the second panel 14 is configured to removably couple to the adhesive 18.

In use, the second panel 14 is peeled away from the adhesive 18. The first panel 12 is positioned so as to overlay the sole of the article of footwear. The adhesive 18 is thus brought into contact with and binds to the debris, such as dirt, mud, fecal matter, gum, grass, sand, bugs, and the like, that is adhering to the sole so that the debris is removed from the sole as the first panel 12 is peeled from the sole. The user then is free to discard the device 10 along with the debris.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the elements is present, unless the context clearly requires that there be only one of the elements.

I claim:

1. A sole cleaning device comprising:
a first panel sized such that the first panel is configured for substantially overlaying a sole of an article of footwear;
an adhesive coupled to and substantially covering an upper surface of the first panel; and
a second panel sized and shaped complementarily to the first panel, the second panel being removably coupled to the adhesive such that the second panel is selectively detachable from the adhesive wherein the first panel is configured overlaying the sole of the article of footwear positioning the adhesive for binding to debris adhering to the sole such that the debris is removed from the sole as the first panel is peeled from the sole.

2. The device of claim 1, further including the first panel having a perimeter shaped complementary to a circumference of the sole of the article of footwear.

3. The device of claim 1, further including the first panel being flexible wherein the first panel is configured for conforming to contours of the sole of the article of footwear.

4. The device of claim 3, further including the first panel comprising at least one of plastic and paper stock.

5. The device of claim 1, further including the adhesive being pressure sensitive type such that the adhesive is configured for bonding under application of light pressure.

6. The device of claim 1, further including the second panel comprising at least one of paper and plastic.

7. The device of claim 6, further including a release agent positioned on a lower face of the second panel such that the second panel is configured for removably coupling to the adhesive.

8. A sole cleaning device comprising:
a first panel sized such that the first panel is configured for substantially overlaying a sole of an article of footwear, the first panel having a perimeter shaped complementary to a circumference of the sole of the article of footwear, the first panel being flexible wherein the first panel is configured for conforming to contours of the sole of the article of footwear, the first panel comprising at least one of plastic and paper stock;
an adhesive coupled to and substantially covering an upper surface of the first panel, the adhesive being pressure sensitive type such that the adhesive is configured for bonding under application of light pressure;
a second panel sized and shaped complementarily to the first panel, the second panel being removably coupled to the adhesive such that the second panel is selectively detachable from the adhesive wherein the first panel is configured overlaying the sole of the article of footwear positioning the adhesive for binding to debris adhering to the sole such that the debris is removed from the sole as the first panel is peeled from the sole, the second panel comprising at least one of paper and plastic; and
a release agent positioned on a lower face of the second panel such that the second panel is configured for removably coupling to the adhesive.
